(19) United States
(12) Patent Application Publication
(10) Pub. No.: US 2026/0018813 A1
(43) Pub. Date: Jan. 15, 2026

(54) RECEPTACLE CONNECTOR

(71) Applicant: Japan Aviation Electronics Industry, Ltd., Tokyo (JP)

(72) Inventor: Kenta Ashibu, Tokyo (JP)

(73) Assignee: Japan Aviation Electronics Industry, Ltd., Tokyo (JP)

(21) Appl. No.: 19/227,967

(22) Filed: Jun. 4, 2025

(30) Foreign Application Priority Data
Jul. 12, 2024 (JP) 2024-112448

(51) Int. Cl. H01R 12/71; H01R 13/02; H01R 13/502

(52) U.S. Cl. CPC H01R 12/716; H01R 13/02; H01R 13/502

(57) ABSTRACT

A receptacle hold-down includes a power supply terminal disposed on a peripheral wall. The power supply terminal is formed in a U-shape opening in a mating direction of a plug connector so as to straddle the peripheral wall, and thereby includes an inward contact piece located on an inner side relative to the peripheral wall and extending in the mating direction, an outward piece located on an outer side relative to the peripheral wall and extending in the mating direction, and a coupling piece coupling the inward contact piece and the outward piece. A gap exists between the inward contact piece and the peripheral wall. When the plug connector mates with the receptacle connector, the inward contact piece moves toward the peripheral wall by contact with the plug connector, and the outward piece moves away from the peripheral wall.

### INCORPORATION BY REFERENCE

This application is based upon and claims the benefit of priority from Japanese patent application No. 2024-112448, filed on Jul. 12, 2024, the disclosure of which is incorporated herein in its entirety by reference.

### BACKGROUND

The present invention relates to a receptacle connector.

As shown in FIG. 8 of the present application, Patent Literature 1 (Japanese Unexamined Patent Application Publication No. 2024-056089) discloses a receptacle connector 103 that includes a housing 100 made of resin, a signal terminal 101 and a hold-down 102 that are held by the housing 100.

The hold-down 102 reinforces the housing 100 and serves as a power supply terminal. The hold-down 102 includes a contact arm 106 that rises from a bottom part 105 and serves as a power supply terminal. A top part 106A of the contact arm 106 is designed to be lower than a top side wall reinforcing part 107 in order to prevent the contact arm 106 from buckling when mating a plug connector with the receptacle connector 103.

### SUMMARY

In the above-described Patent Literature 1, there is room for improvement concerning robustness against misaligned mating.

An object of the present disclosure is to provide a technique for improving the robustness of a terminal of a hold-down against misaligned mating without sacrificing the springiness of the terminal.

There is provided a receptacle connector configured to mate with an opponent connector, the receptacle connector including a housing where a peripheral wall projects from a bottom plate, and a hold-down held by the housing, wherein the hold-down includes a terminal to be disposed on the peripheral wall, the terminal is formed in a U-shape opening in a mating direction of the opponent connector so as to straddle the peripheral wall, and thereby includes an inward contact piece located on an inner side relative to the peripheral wall and extending in the mating direction, an outward piece located on an outer side relative to the peripheral wall and extending in the mating direction, and a coupling piece coupling the inward contact piece and the outward piece, a gap exists between the inward contact piece and the peripheral wall, and when the opponent connector mates with the receptacle connector, the inward contact piece moves toward the peripheral wall by contact with the opponent connector, and the outward piece moves away from the peripheral wall.

According to the present disclosure, the terminal is formed to straddle the peripheral wall, which improves the robustness of the terminal against misaligned mating. Further, the inward contact piece and the outward piece of the terminal move in the same direction relative to the peripheral wall when mating the connectors, so that the springiness of the inward contact piece is not sacrificed compared with the case where the outward piece is fixed relative to the peripheral wall.

The above and other objects, features and advantages of the present disclosure will become more fully understood from the detailed description given hereinbelow and the accompanying drawings.

### BRIEF DESCRIPTION OF DRAWINGS

FIG. 1 is a perspective view of a connector assembly;

FIG. 2 is an exploded perspective view of the receptacle connector;

FIG. 3 is an exploded perspective view of the receptacle connector;

FIG. 4 is a partially cutout perspective view of a receptacle hold-down;

FIG. 5 is a cross-sectional view of the receptacle connector before mating the connectors;

FIG. 6 is a cross-sectional view of the receptacle connector after mating the connectors;

FIG. 7 is a perspective view of the receptacle connector; and

FIG. 8 is a view showing a simplified version of FIG. 1 of Patent Literature 1.

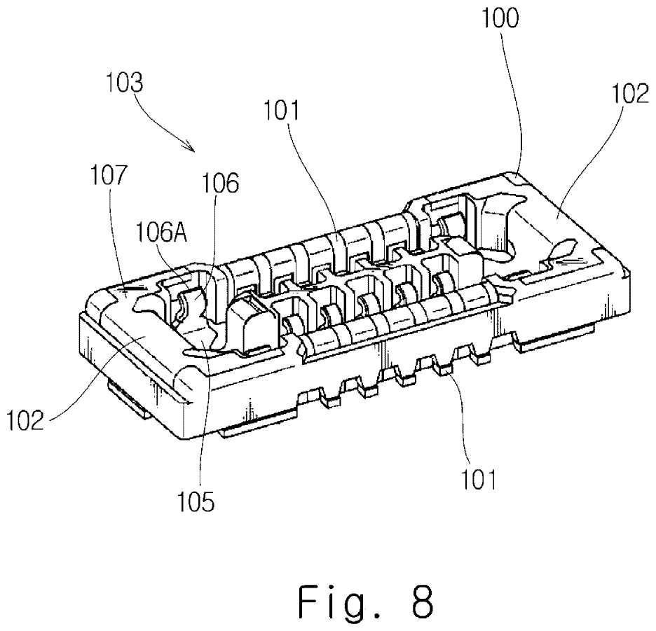

### DESCRIPTION OF EMBODIMENTS

Although the present disclosure will be described hereinafter through an embodiment, the disclosure defined by the scope of claims is not limited to the following embodiments. Further, not all of the elements described in the embodiment are essential as a solution to problem. The following description and the drawings are appropriately shortened and simplified to clarify the explanation. In the drawings, the identical reference symbols denote identical structural elements and the redundant explanation thereof is omitted according to need.

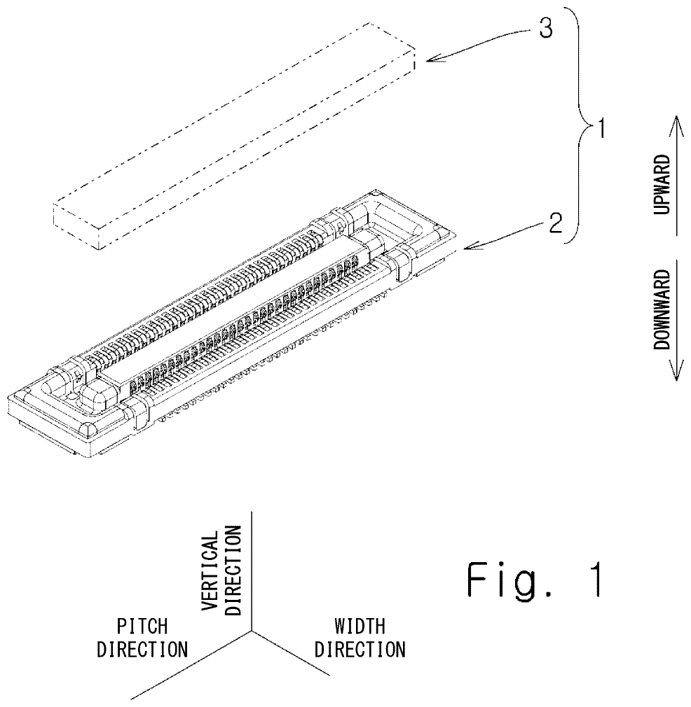

An embodiment of the present disclosure will be described hereinafter with reference to FIGS. 1 to 7.

FIG. 1 shows a connector assembly 1 that mechanically and electrically connects two boards parallel to each other. The connector assembly 1 includes a receptacle connector 2 to be mounted on a receptacle side board, which is one of the two boards, and a plug connector 3 to be mounted on a plug side board, which is the other board.

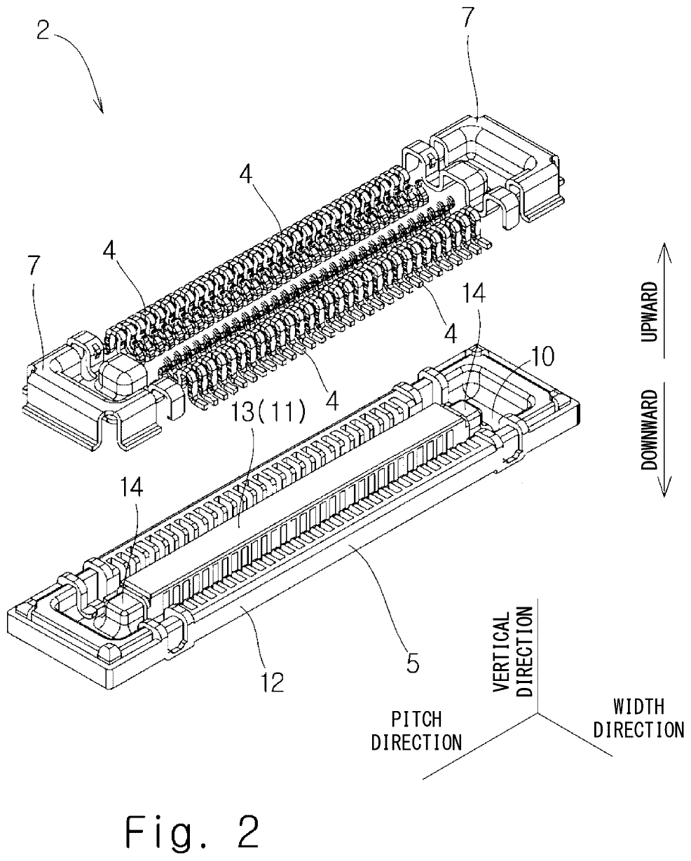

FIG. 2 is an exploded perspective view of the receptacle connector 2. As shown in FIG. 2, the receptacle connector 2 includes a plurality of receptacle contacts 4, a receptacle housing 5 that holds the plurality of receptacle contacts 4, and two receptacle hold-downs 7. Each of the receptacle contacts 4 is one specific example of a contact. The receptacle housing 5 is one specific example of a housing. Each of the receptacle hold-downs 7 is one specific example of a hold-down.

The plurality of receptacle contacts 4 are arranged in two rows along the longitudinal direction of the receptacle connector 2.

Referring now to FIGS. 1 and 2, a “vertical direction”, a “pitch direction” and a “width direction” will be defined. The vertical direction, the pitch direction, and the width direction are perpendicular to each other.

As shown in FIG. 1, the vertical direction is a direction in which the plug connector 3 is inserted into and removed from the receptacle connector 2. Therefore, the vertical direction coincides with the height direction of the receptacle connector 2, and also coincides with the height direction of the plug connector 3. The vertical direction includes an upward direction (a removing direction) and a downward direction (a mating direction). The upward direction is a direction in which the plug connector 3 is removed from the receptacle connector 2. The downward direction is a direction in which the plug connector 3 mates with the receptacle connector 2. The terms “upward” and “downward” are used just for the sake of simplifying the explanation, and do not specify the position of the connector assembly 1 when it is actually used.

As shown in FIG. 2, the pitch direction is a direction in which the plurality of receptacle contacts 4 are lined up. In the case where the plurality of receptacle contacts 4 are arranged in two rows parallel to each other as described in this embodiment, the pitch direction can be defined as a direction in which the plurality of receptacle contacts 4 belonging to one of the two rows are lined up. The pitch direction includes inward in the pitch direction and outward in the pitch direction. The inward in the pitch direction is a direction toward the center of the connector assembly 1 in the pitch direction. The outward in the pitch direction is a direction receding from the center of the connector assembly 1 in the pitch direction.

The width direction is a direction perpendicular to the vertical direction and the pitch direction. The width direction includes inward in the width direction and outward in the width direction. The inward in the width direction is a direction toward the center of the connector assembly 1 in the width direction. The outward in the width direction is a direction receding from the center of the connector assembly 1 in the width direction.

### (Receptacle Connector 2)

Referring to FIGS. 2 to 7, the receptacle connector 2 will be described hereinafter in detail. As described above, the receptacle connector 2 includes the plurality of receptacle contacts 4, the receptacle housing 5 that holds the plurality of receptacle contacts 4, and the two receptacle hold-downs 7.

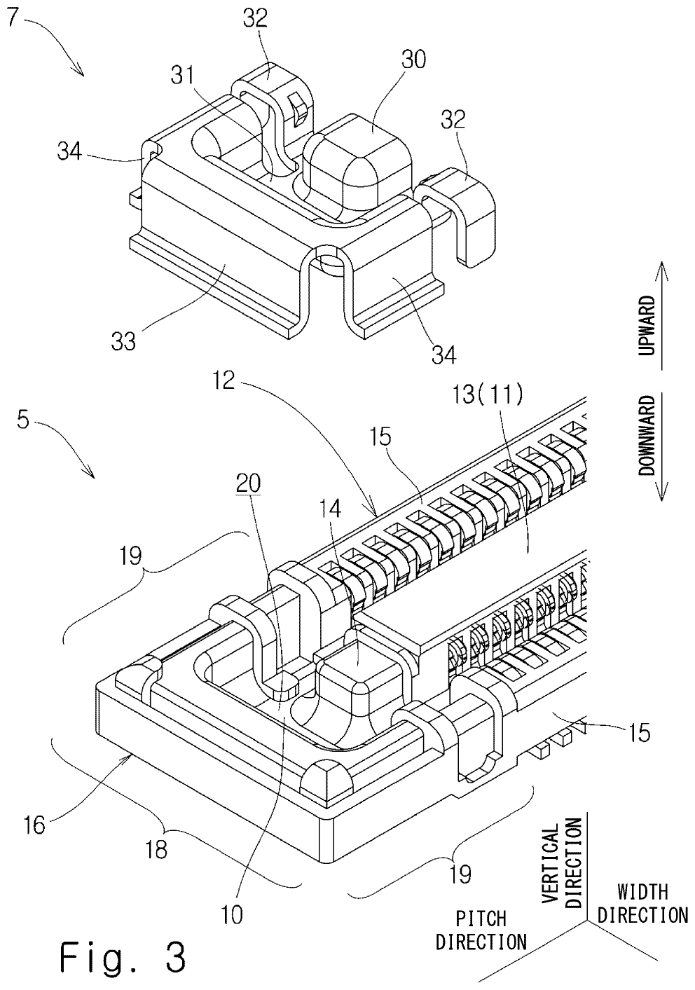

FIG. 3, like FIG. 2, is an exploded perspective view of the receptacle connector 2. As shown in FIGS. 2 and 3, the receptacle housing 5 is a plate member that is made of an insulating resin and has a rectangular shape when viewed from above, and it is elongated in the pitch direction. The receptacle housing 5 includes a bottom plate 10, an island part 11, and a peripheral wall 12. The island part 11 is omissible.

The bottom plate 10 is a flat plate whose thickness direction is in the vertical direction.

The island part 11 projects upward from the center of the bottom plate 10 in the pitch and width directions, and extends in an elongated shape in the pitch direction. The island part 11 includes an island main part 13 and two island end parts 14. The two island end parts 14 respectively correspond to both ends of the island part 11 in the pitch direction. The island main part 13 is a part between the two island end parts 14. The two island end parts 14 are adjacent to the island main part 13 in the pitch direction.

The peripheral wall 12 is formed in an annular shape so as to surround the island part 11 when viewed from above, and it projects upward from the bottom plate 10, just like the island part 11. As shown in FIG. 3, the peripheral wall 12 includes two contact holding walls 15 that hold the plurality of receptacle contacts 4, and two hold-down holding walls 16 that hold the two receptacle hold-downs 7, respectively. FIG. 3 shows only one of the two hold-down holding walls 16 for the sake of simplifying the explanation. The island part 11 and the two contact holding walls 15 are disposed between the two hold-down holding walls 16 in the pitch direction.

Each of the contact holding walls 15 is disposed so as to be opposed to the island part 11 in the width direction.

Each of the hold-down holding walls 16 is disposed so as to be opposed to the island part 11 in the pitch direction. Each of the hold-down holding walls 16 is formed in a U-shape that opens inward in the pitch direction when viewed from above. Specifically, each of the hold-down holding walls 16 includes a first holding wall 18 that extends in the width direction and is opposed to the island part 11 in the pitch direction, and a second holding wall 19 that extends in the pitch direction and is opposed to the island part 11 in the width direction.

Further, the peripheral wall 12 is formed annularly with spaces from the island part 11 in the pitch and width directions, so that an annular mating recessed part 20 is formed between the island part 11 and the peripheral wall 12.

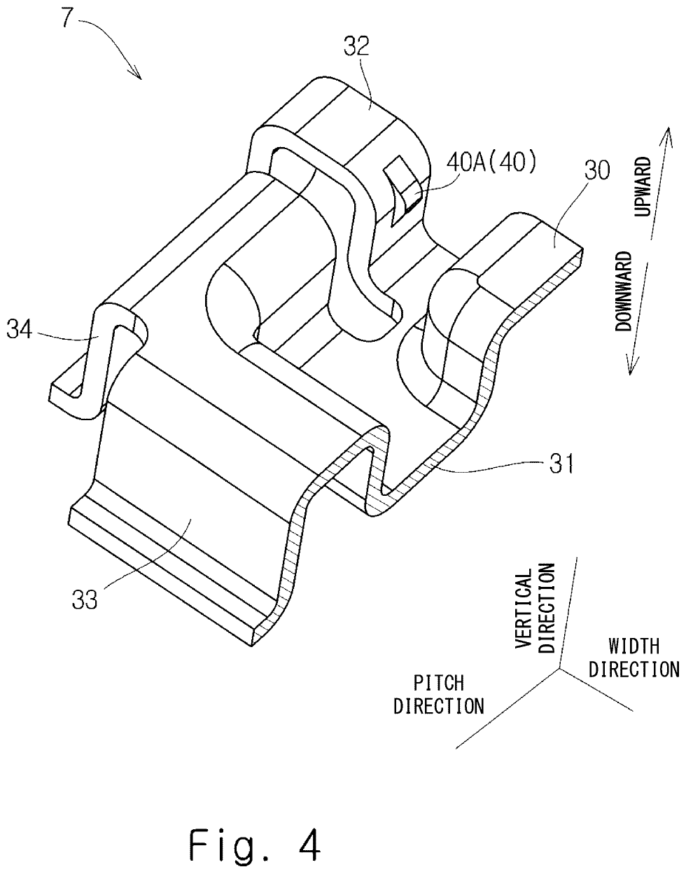

In this embodiment, each of the receptacle hold-downs 7 mainly provides a function of protecting the receptacle housing 5 when mating the connectors, a function of fixing the receptacle connector 2 to the receptacle side board, and a function as a power supply terminal. FIG. 4 is a partially cutout perspective view of the receptacle hold-down 7. As shown in FIGS. 3 and 4, each receptacle hold-down 7 is typically formed by punching and drawing one metal plate. In this embodiment, each receptacle hold-down 7 is integrated with the hold-down holding wall 16 of the receptacle housing 5 by insert-molding. Since the two receptacle hold-downs 7 have the same shape, one of the receptacle hold-downs 7 will be described hereinafter, and description of the other one will be omitted. Note that, instead of integrating the receptacle hold-down 7 with the hold-down holding wall 16 of the receptacle housing 5 by insert-molding, the receptacle hold-down 7 may be held to the hold-down holding wall 16 of the receptacle housing 5 typically by press-fitting the receptacle hold-down 7 to the hold-down holding wall 16 of the receptacle housing 5.

Referring still to FIGS. 3 and 4, the receptacle hold-down 7 includes a cup part 30, a flange part 31, two power supply terminals 32, a first protective part 33, and two second protective parts 34.

The cup part 30 protects the island end part 14 of the island part 11 of the receptacle housing 5. To be specific, the cup part 30 is formed in a cup-shape that opens downward and inward in the pitch direction, and accommodates and protects the island end part 14. The cup part 30 is one specific example of an island part protector.

The flange part 31 connects the cup part 30, the two power supply terminals 32, the first protective part 33, and the two second protective parts 34 with one another. To be specific, the flange part 31 extends from the lower end of the cup part 30 so as to expand outward in the pitch direction and outward in the width direction. The thickness direction of the flange part 31 coincides with the vertical direction.

The two power supply terminals 32 supply power supply voltages to the plug connector 3 when mating the connectors. To be specific, the two power supply terminals 32 are disposed so as to be opposed to the cup part 30 in the width direction. Since the two power supply terminals 32 are symmetric to each other, one of the power supply terminals 32 will be described hereinafter, and description of the other one will be omitted.

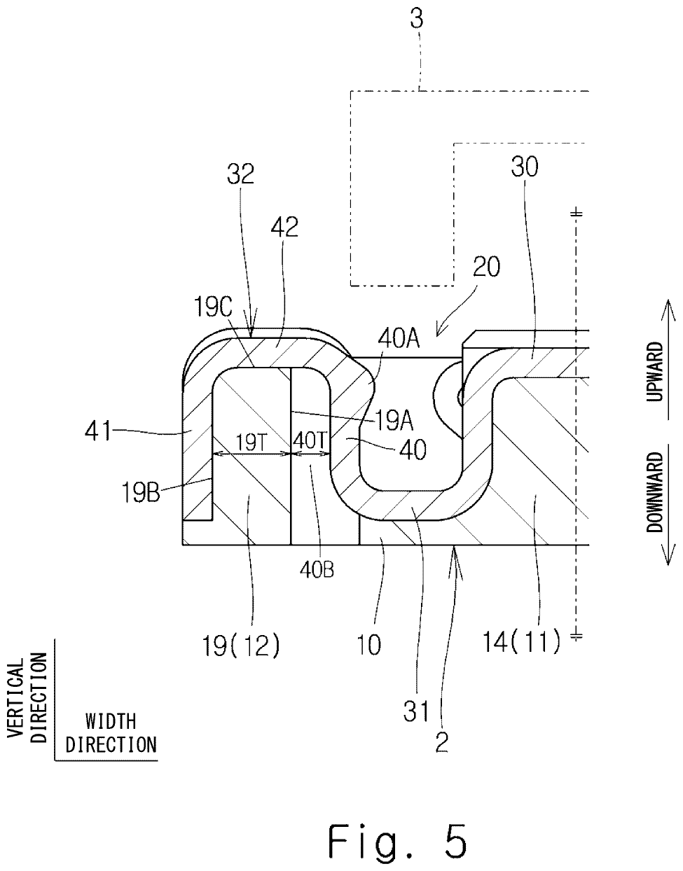

The power supply terminal 32 is one specific example of a terminal. The power supply terminal 32 is disposed on the second holding wall 19 of the hold-down holding wall 16 of the peripheral wall 12. FIG. 5 is a cross-sectional view of the receptacle connector 2 before mating the connectors. As shown in FIG. 5, the power supply terminal 32 is formed in a U-shape that opens downward so as to straddle the second holding wall 19. Specifically, the power supply terminal 32 includes an inward contact piece 40, an outward piece 41, and a coupling piece 42.

The second holding wall 19 has a rectangular cross section, and includes an inward surface 19A facing inward in the width direction, an outward surface 19B facing outward in the width direction, and an upper surface 19C facing upward.

The inward contact piece 40 is opposed to the inward surface 19A of the second holding wall 19 in the width direction. In other words, the inward contact piece 40 is disposed inward in the width direction relative to the second holding wall 19. The inward contact piece 40 extends in the vertical direction. The inward contact piece 40 extends to project upward from the flange part 31. The inward contact piece 40 has a contact projecting part 40A for stabilizing a contact position with a power supply terminal, which is not shown, of the plug connector 3. The contact projecting part 40A projects inward in the width direction. A gap 40B exists between the inward contact piece 40 and the second holding wall 19.

The outward piece 41 is opposed to the outward surface 19B of the second holding wall 19 in the width direction. In other words, the outward piece 41 is disposed outward in the width direction relative to the second holding wall 19. The outward piece 41 extends in the vertical direction. The outward piece 41 is in close contact with the second holding wall 19 by insert molding in the state before mating the connectors.

The coupling piece 42 is opposed to the upper surface 19C of the second holding wall 19 in the vertical direction. In other words, the coupling piece 42 is disposed upper than the second holding wall 19. The coupling piece 42 extends in the width direction. The coupling piece 42 is in close contact with the second holding wall 19 by insert molding in the state before mating the connectors. The coupling piece 42 connects the upper end of the inward contact piece 40 and the upper end of the outward piece 41 with each other.

Referring back to FIGS. 3 and 4, the first protective part 33 protects the first holding wall 18 of the hold-down holding wall 16. To be specific, the first protective part 33 is formed in a U-shape that opens downward, and exposed upward to protect the first holding wall 18 when mating the connectors.

The two second protective parts 34 protect the two second holding walls 19 of the hold-down holding wall 16, respectively. To be specific, each of the second protective parts 34 is formed in a U-shape that opens downward, and exposed upward to protect each of the second holding walls 19 when mating the connectors.

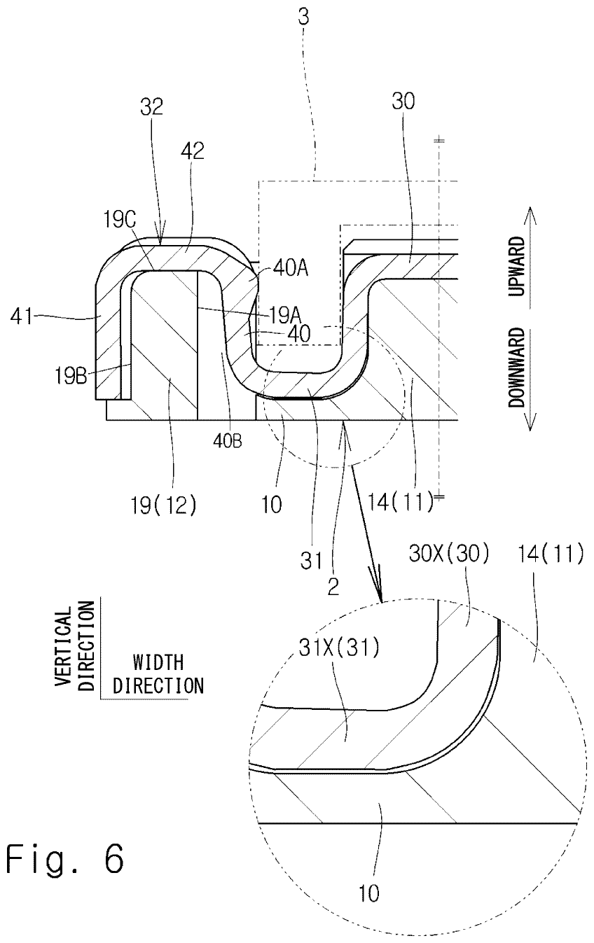

In this structure, when the plug connector 3 mates with the receptacle contact 4, the plug connector 3 is inserted into the mating recessed part 20 in FIG. 5. The contact projecting part 40A of the inward contact piece 40 of the power supply terminal 32 then comes into contact with the power supply terminal of the plug connector 3, and thereby the contact projecting part 40A is pushed outward in the width direction. FIG. 6 is a cross-sectional view of the connector assembly 1 after mating the connectors. As shown in FIG. 6, when the contact projecting part 40A is pushed outward in the width direction, the entire power supply terminal 32 moves outward in the width direction.

In more detail, as the contact projecting part 40A moves outward in the width direction, the inward contact piece 40 leans outward in the width direction with its lower end being restrained by the flange part 31. In brief, the inward contact piece 40 moves toward the second holding wall 19.

Further, as the contact projecting part 40A moves outward in the width direction, the coupling piece 42 comes off the upper surface 19C of the second holding wall 19 and moves outward in the width direction, remaining in contact with the upper surface 19C of the second holding wall 19.

Further, as the contact projecting part 40A moves outward in the width direction, the outward piece 41 comes off the outward surface 19B of the second holding wall 19 and moves outward in the width direction, away from the outward surface 19B of the second holding wall 19. In other words, the outward piece 41 moves away from the second holding wall 19.

As described above, in the structure of this embodiment, as the contact projecting part 40A moves outward in the width direction, the entire power supply terminal 32 moves outward in the width direction. This allows the contact projecting part 40A to easily move outward in the width direction compared with the case where the outward piece 41 and the coupling piece 42 are fixed to the second holding wall 19 and immobile relative to the second holding wall 19, for example, which achieves the power supply terminal 32 having flexible springiness.

Further, as shown in FIGS. 5 and 6, the power supply terminal 32 is formed in a U-shape that opens downward so as to straddle the second holding wall 19. Thus, even when the plug connector 3 is pushed toward the receptacle contact 4 in the state where the plug connector 3 is displaced relative to the receptacle contact 4 in the width direction when mating the connectors and thereby a downward load acts on the power supply terminal 32, this load is borne by the second holding wall 19, which prevents buckling distortion of the power supply terminal 32 in the vertical direction. In short, this structure provides high robustness of the power supply terminal 32 against misaligned mating.

Further, in this embodiment, the coupling piece 42 is in contact with the upper surface 19C of the second holding wall 19 in the state before mating the connectors. Thus, even when a downward load acts on the power supply terminal 32, this load is immediately borne by the second holding wall 19, and the power supply terminal 32 is thereby not elastically deformed downward. This further enhances robustness of the power supply terminal 32 against misaligned mating compared with the case where the coupling piece 42 is not in contact with the second holding wall 19 in the state before mating the connectors.

Further, as shown in FIG. 5, a thickness 19T of the second holding wall 19 in the width direction is greater than a thickness 40T of the gap 40B in the width direction. This allows the contact projecting part 40A to move outward in the width direction to a certain extent and also allows the second holding wall 19 to have a sufficient strength to bear the above-described load.

Note that, as shown in FIG. 6, in this embodiment, as the contact projecting part 40A of the inward contact piece 40 moves outward in the width direction, a part 31X of the flange part 31 between the cup part 30 and the power supply terminal 32 in the width direction and a part 30X of the cup part 30 that is opposed to the inward contact piece 40 in the width direction come off the bottom plate 10 and the island part 11, respectively, and are slightly displaced outward in the width direction. In this manner, since the part 31X of the flange part 31 and the part 30X of the cup part 30 come off the receptacle housing 5 and are displaced outward in the width direction as the contact projecting part 40A of the inward contact piece 40 moves outward in the width direction, the contact projecting part 40A more easily moves outward in the width direction, and the springiness of the power supply terminal 32 is further improved. Note that, however, it is not essential that the part 31X of the flange part 31 and the part 30X of the cup part 30 come off the receptacle housing 5 and are displaced outward in the width direction as the contact projecting part 40A of the inward contact piece 40 moves outward in the width direction. In other words, the structure where the part 31X of the flange part 31 and the part 30X of the cup part 30 do not come off the receptacle housing 5 when the contact projecting part 40A of the inward contact piece 40 moves outward in the width direction is also feasible.

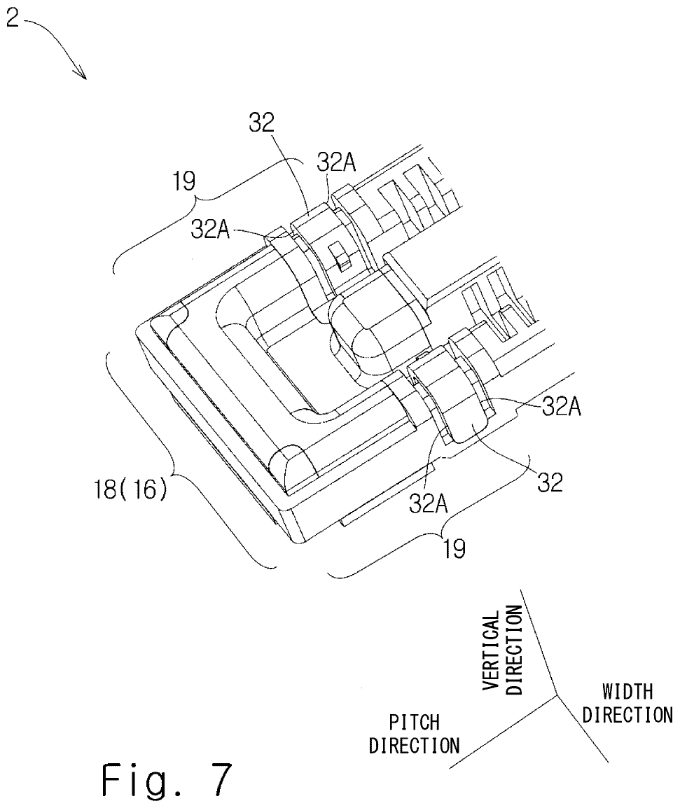

FIG. 7 is a perspective view of the receptacle connector 2. As shown in FIG. 7, a side surface 32A of each power supply terminal 32 is not in contact with the corresponding second holding wall 19. This allows each power supply terminal 32 to more easily move when mating the connectors compared with the case where the side surface 32A of each power supply terminal 32 is in close contact with the second holding wall 19 by insert molding, and thereby allows each power supply terminal 32 to have sufficient springiness.

A preferred embodiment of the present disclosure is described above. The above-described embodiment has the following features.

The receptacle connector 2 includes the receptacle housing 5 (housing) where the peripheral wall 12 projects from the bottom plate 10, and the receptacle hold-down 7 (hold-down) that is held by the receptacle housing 5. The receptacle connector 2 is configured to mate with the plug connector 3 (opponent connector). The receptacle hold-down 7 includes the power supply terminal 32 (terminal) to be disposed on the peripheral wall 12. The power supply terminal 32 is formed in a U-shape that opens in the mating direction of the plug connector 3 so as to straddle the peripheral wall 12, and thereby includes the inward contact piece 40 that is located on the inner side relative to the peripheral wall 12 and extends in the mating direction, the outward piece 41 that is located on the outer side relative to the peripheral wall 12 and extends in the mating direction, and the coupling piece 42 that couples the inward contact piece 40 and the outward piece 41. The gap 40B exists between the inward contact piece 40 and the peripheral wall 12. When the plug connector 3 mates with the receptacle connector 2, the inward contact piece 40 moves toward the peripheral wall 12 by contact with the plug connector 3, and the outward piece 41 moves away from the peripheral wall 12. In this structure, since the power supply terminal 32 is formed to straddle the peripheral wall 12, the robustness of the power supply terminal 32 against misaligned mating is improved. Further, since the inward contact piece 40 and the outward piece 41 of the power supply terminal 32 move in the same direction relative to the peripheral wall 12 when mating the connectors, the springiness of the inward contact piece 40 is not sacrificed compared with the case where the outward piece 41 is fixed relative to the peripheral wall 12.

Further, the receptacle housing 5 includes the island part 11 that projects, along with the peripheral wall 12, from the bottom plate 10 on the inner side of the peripheral wall 12. The receptacle hold-down 7 integrally includes the cup part 30 (island part protector) that protects the island end part 14 of the island part 11, and the power supply terminal 32. In this structure, the receptacle connector 2 with a small number of parts is achieved.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A receptacle connector configured to mate with an opponent connector, the receptacle connector comprising:
a housing where a peripheral wall projects from a bottom plate; and
a hold-down held by the housing, wherein
the hold-down includes a terminal to be disposed on the peripheral wall,
the terminal is formed in a U-shape opening in a mating direction of the opponent connector so as to straddle the peripheral wall, and includes an inward contact piece located on an inner side relative to the peripheral wall and extending in the mating direction, an outward piece located on an outer side relative to the peripheral wall and extending in the mating direction, and a coupling piece coupling the inward contact piece and the outward piece,
a gap exists between the inward contact piece and the peripheral wall, and
when the opponent connector mates with the receptacle connector, the inward contact piece moves toward the peripheral wall by contact with the opponent connector, and the outward piece moves away from the peripheral wall.

2. The receptacle connector according to claim 1, wherein a thickness of the peripheral wall is greater than a thickness of the gap in a direction along which the inward contact piece and the outward piece are opposed to each other.

3. The receptacle connector according to claim 1, wherein the coupling piece is in contact with the peripheral wall before mating the connectors.

4. The receptacle connector according to claim 1, wherein a side surface of the terminal is not in contact with the peripheral wall.

5. The receptacle connector according to claim 1, wherein
the housing includes an island part that projects, along with the peripheral wall, from the bottom plate, and
the hold-down integrally includes an island part protector that protects the island part, and the terminal.
